(19) United States
(12) Patent Application Publication
(10) Pub. No.: US 2012/0037775 A1
(43) Pub. Date: Feb. 16, 2012

(54) TILTING SUPPORT FOR PLASMA TELEVISION SETS AND SIMILAR APPLIANCES

(76) Inventor: Carlos Sangiuliano, Sao Paulo-SP (BR)

(21) Appl. No.: 13/003,120

(22) PCT Filed: Apr. 30, 2009
(86) PCT No.: PCT/BR2009/000118

§ 371 Date: Jan. 7, 2011

(51) Int. Cl. F16M 11/10

(52) U.S. Cl. 248/274.1

(57) ABSTRACT

A tilting support for plasma television sets and similar appliances combines in a single element the functions of fixing and levelling according to the desired position of the television set on walls, provides greater comfort and easiness to the user, dispensing the use of other elements for the mobility of the television set. It consists of a fixed support with mounting slots (2) for screws that will be introduced into sleeves on the wall or other desired place and lateral perforations (5) to 12 assemble a central axis between the mobile part and the fixed one for forming an assembly, where the mobile part consists of a pulley (10) for coupling the TV set, a hinge and a locking screw (12) for the pulley (10) and a spirit level for levelling the support. The support is characterized as universal because it promotes the installation on independent fixing 11 points, it is easily adaptable and it does not require the previous determination of the distance between perforations contained on the television

The present Patent Request of a Utility Model refers to a Universal support kit for holding plasma television sets or those of LCD (“liquid crystal display”) on walls, to which was given an original building disposition, since it is a safe support, of low cost and of easy installation in relation to other models found in the market.

The use of plasma or LCD (“liquid crystal display”) television monitors has been expanding, and associated to this fact, also arouse the need to develop adequate devices for their attachment and support on their use location, since, conceptually, these monitors were made to take the least space possible on tables, shelves, or even to be fixed directly on the walls. Thus, an immediate concern has been to develop fixing and supporting devices for LCD and plasma television monitors that attend the standard VESA 5 “Mounting”.

The Flat Display Mounting Interface (FDMI), also known as “VESA Mounting Interface Standard” (MIS) or commonly as VESA, belongs to a family of rules defined by the Video Electronics Standards Association (VESA) for mounting flat screen or LCD monitors, televisions and other monitors for shelves or walls. Such rules are aimed at standardizing the mounting of modern monitors, screens and television sets. The first standard in this family was introduced in 1997 and was originally called “Flat Panel Monitor Physical Mounting Interface” (FPMPMI). The mounting standard VESA MIS-D consists on four screws organized in a square, with the horizontal and vertical distances between the screws of about 100 mm. Such standard still is the configuration used for desk top computer monitors. The standard for smaller sized monitors was defined as 75 mm×75 mm.

The mounting standard VESA MIS-D 25 adopts 10 mm perforations and M4 threads. Adequate fixers (typically 10 mm) are usually supplied with mounting; however, they are easily obtained in hardware stores. FDMI was extended in 2006 with a collection of more standard screws, which are more adequate for larger plasma monitors. The following standardized measures are now in use:

MIS-D 75: 75 mm×75 mm;
MIS-D 100:5 100 mm×100 mm;
MIS-F: 200 mm×200 mm, 400 mm×400 mm, 600 mm×200 mm, 600 mm×400 mm, 800 mm×400 mm and 280 mm×150 mm.

Examples of complete identification of a mounting with FDMI mounting standard are:

### VESA MIS-D, 100, C;

### VESA MIS-F, 200, 200, 6;

The code after the MIS abbreviation identifies the part of the standard used; for example: B, C, D, E for flat screens with 10 cm to 78 cm of diagonal length; F for flat screens with 79 cm to 230 cm of diagonal length;—for the letter D: variation can occur in the diagonal for part D, one number identifies the variations of 75 mm and 100 mm (100 or 75);—for the letter F: one pair of numbers identifies the maximum width and height of the standard measures of the orifices;—for the letters B and E: the final letter identifies the location of the flat screen monitor interface, such as center (C), top (T), back (B), left (L), right (R), top and back (T/B), or left and right (L/R);—for the letter F: the final digit distinguishes between 10 mm perforation and screw M6 and 15 mm perforation and screw M8.

Besides the perforation standards, the regulation also specifies requirements for the location of cables (Source: Flat Display Mounting Interface Standard 5 (FDMI), 1.0 Revision 1, VESA-2006-2, Video Electronics Standards Association, January 2006).

In face of this standardization, in the particular case of plasma television sets, some types of fixers were developed. The requests MU 8501495-8, MU 8502626-3 and UM 8600981-8 contain examples of plasma television supports found in the market; however, with limitations in relation to their versatility, safety on installation and fixation and tilting.

In order to solve such inconveniences, the present universal support kit for plasma television sets and similar appliances can be installed in any television model or thin screen with VESA standard, or not, and with a load capacity above that of commonly found supports, becoming universal and adaptable to any model of plasma or LCD television sets.

Because it is formed by elements that promote independent fixing points and tilting mobility it becomes a universal model, easily adaptable and dispensing the previous determination of the distance between perforations on the television set, within VESA standards, at the purchase time, thus obtaining an accessory with the least possible number of parts, conveniently shaped and arranged to perform their functions with unmatchable efficacy and versatility and without the inconveniences previously mentioned.

Its innovative shape allows obtaining an excellent level of applicability, offering a support model which, presenting an excellent finishing in electrozinc metal sheet and electrostatic painting has great durability and resistance.

Such universal support kit consists of a fixed support with perforations for screws that will be introduced into sleeves in the wall or area where it will be fixed, lateral perforations for coupling the central axis between the fixed and mobile parts, forming a set, and the mobile part consists of a pulley for coupling the television set, support, pulley locking screw and spirit for leveling the support.

The support kit can be better understood from the following detailed description, according to the figures attached, where:

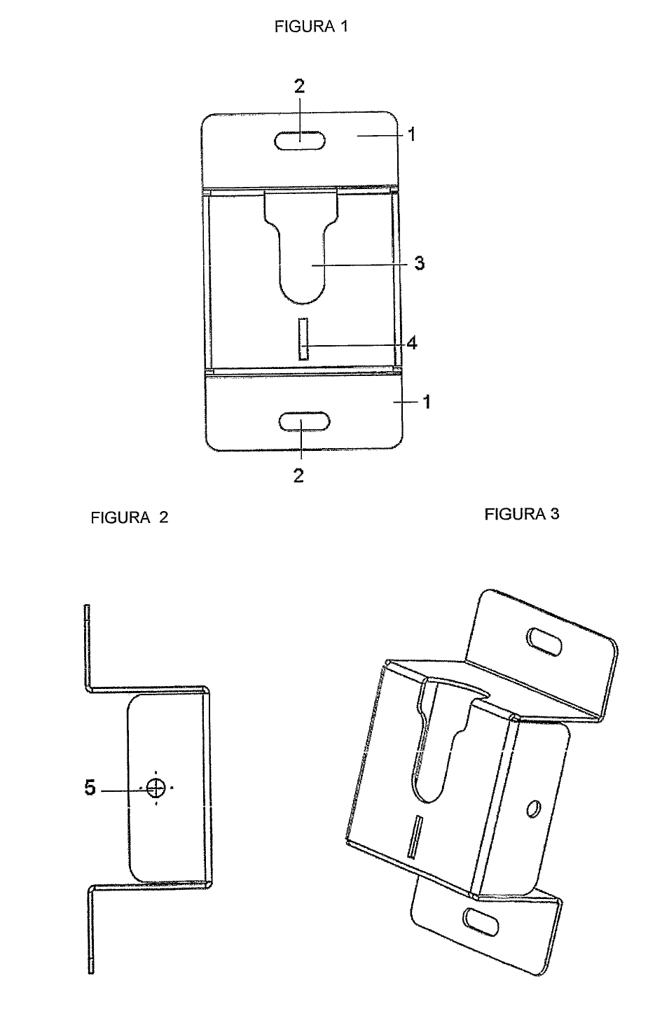

FIG. 1—Depicts a frontal perspective view of the fixed support, an integral part of the support kit for television sets.

1—Universal support;

2—Perforation for fixing the support on the wall;

3—Perforation for coupling the pulley;

4—Rectangular perforation for coupling the measuring tape (measurement reference for assembling the support).

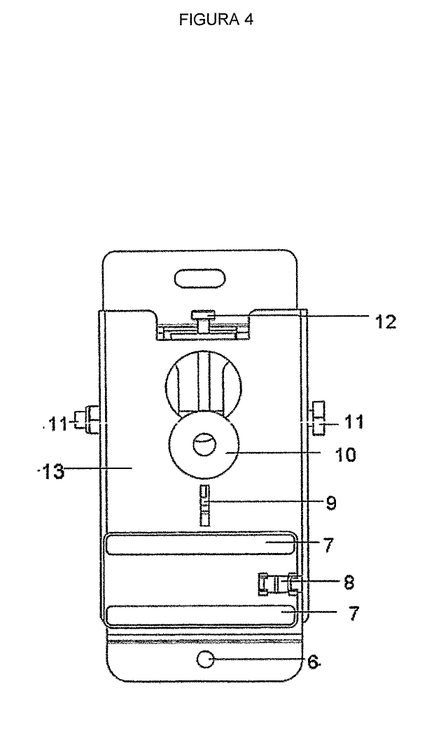

FIG. 2—Depicts a side view of the fixed support, an integral part of the support kit for television sets.

5—Perforation for fixing the central axis screw (it is used to fix the mobile support for tilting).

FIG. 3—Depicts a perspective view of the fixed support, an integral part of the support kit for television sets.

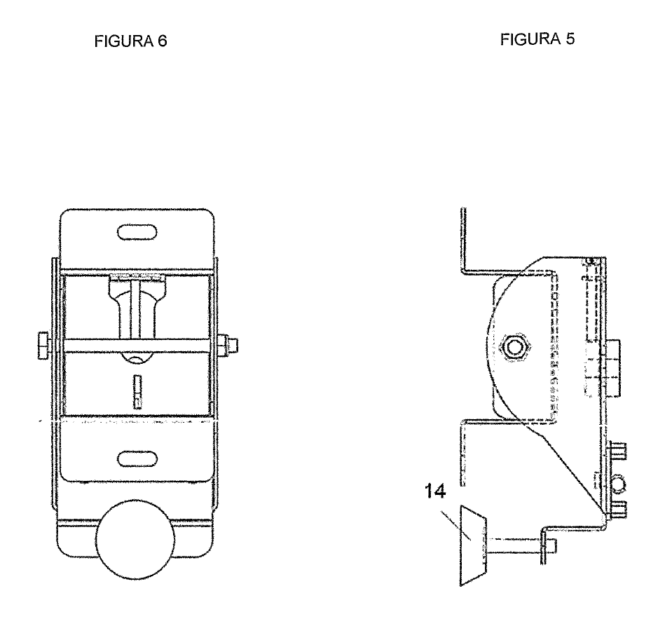

FIG. 4—Depicts a front view of the support kit, with the fixed and mobile parts assembled.

6—Perforation for coupling the tilting regulator;

7—Support;

8—Spirit for leveling the support;

9—Rectangular split;

10—TV support coupling pulley;

11—Screw of the central axis of the support;

12—Screw for pulley locking;

13—Mobile support for tilting;

FIG. 5—Depicts a side view of the support kit for television sets.

14—Tilting regulator;

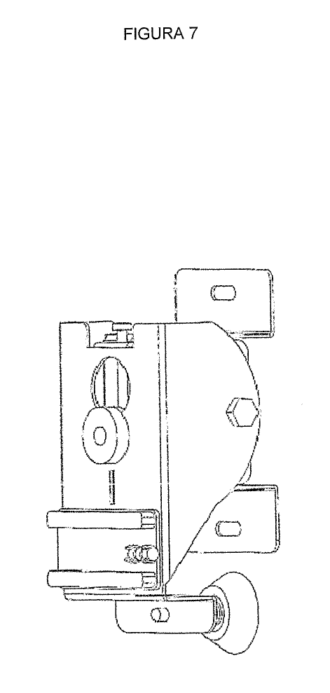

FIG. 6—Depicts a bottom view of the support kit for television sets.

FIG. 7—Depicts a perspective front view of the support kit completely assembled.

Based on these pictures, the support kit (FIG. 7) can be observed, consisted of a group of fixing elements divided into two parts, a fixed support (FIG. 1, 2, 3) with upper and lower perforations (FIG. 1 number 2) that will receive screws that will be introduced in the sleeves on the wall or fixation area.

The universal support kit also presents lateral perforations (FIG. 2 number 5) for coupling a central axis (FIG. 4 number 11) that will be connected to the fixed support (FIG. 1, 2, 3) and a mobile support (FIG. 4 number 13) forming an assembly (FIG. 7), where the mobile part is responsible for tilting the television set fixed on the support by a pulley (FIG. 4 number 10) that receives a central screw (FIG. 4 number 12) for locking it in the desired position.

There are two plastic rims (FIG. 4 number 7) on the front of the support kit that function as wedges/supports, since the television set receives the pulley on its back (FIG. 4 number 10) leaving it without a support basis.

A spirit (FIG. 4 number 8) is a part of the kit and is fixed on its front to aid on the correct assembly of the television set, indicating when it is leveled.

The installation of the support kit can be done by screwing the fixed part of the support on the wall or another desired location, using the upper and lower perforations (FIG. 1 number 2).

The use of the spirit at assembly has as major function the leveling to the support kit on the wall (FIG. 4 number 8) to maintain the television set leveled.

The support kit performance consists on fixing the support on the wall and placing the television set on it through the pulley (FIG. 4 num. 10), turning the tilting regulator (FIG. 5 num. 14), causing the vertical movement of the mobile support.

1. “INTRODUCED DISPOSITION FOR A UNIVERSAL TILTING SUPPORT FOR PLASMA TELEVISION SETS AND SIMILAR APPLIANCES”, characterized by consisting of a fixed support (FIG. 1,2,3) with lower and upper perforations (FIG. 1 num. 2) lateral perforations (FIG. 2 num. 5), central axis (FIG. 4 num. 12), between the mobile/fixed parts (FIG. 4 num. 13) forming an assembly (FIG. 7) where the mobile part comprises a grooved disk (pulley) (FIG. 4 num. 10) to couple on the TV, support/stop located below the grooved disk, locking screw (FIG. 4 num. 12) for the disk and spirit for leveling the support.
